(19) United States
(12) Patent Application Publication
(10) Pub. No.: US 2011/0000402 A1
(43) Pub. Date: Jan. 6, 2011

(54) System and Method for Handling Recyclable Materials and Products Manufactured Therefrom

(76) Inventor: Louis P. Grasso, JR., New Rochelle, NY (US)

Correspondence Address: GORDON & JACOBSON, P.C., 60 LONG RIDGE ROAD, SUITE 407, STAMFORD, CT, 06902, US

(21) Appl. No.: 12/497,979

(22) Filed: Jul. 6, 2009

(51) Int. Cl. G06Q 10/00; C04B 28/04

(52) U.S. Cl. 106/713; 700/115; 705/6; 705/8; 705/308

(57) ABSTRACT

A system and method for handling recyclable materials and products manufactured therefrom is provided. The method includes receiving recyclable material extracted from post consumer and post industrial sources at a manufacturing facility, acquiring information associated with the recyclable material received at the manufacturing facility, such as properties and certification(s) relating thereto, and storing the acquired information in a database for subsequent access. The recycling method may also include manufacturing a product at the manufacturing facility from the recyclable material, generating product information associated with the product such as properties and certification(s) relating thereto, and storing the product information in the database. The product may then be shipped with the product information and certification information stored in a tangible medium to provide quality certified “green” recycled products for use in building construction.

### BACKGROUND OF THE INVENTION

1. Field of the Invention

This invention relates broadly to methods and systems for handling recyclable materials and products manufactured from recyclable materials. More particularly, this invention relates to methods and systems for handling post-consumer and post-industrial recyclable materials for processing a manufactured product.

2. State of the Art

Various companies, municipalities, and governments engage in and/or promote material recycling in order to avoid the disposal of potentially useful reusable materials, to reduce the consumption of new raw materials, to reduce overall energy consumption, and to promote products and services which are more environment-friendly (e.g. result in less waste, emissions, pollutants, etc.). Typically, recyclable materials such as glass, paper, and plastic are brought to a centralized location from one or more pickup sites. At the centralized location, the recyclable materials are sorted and cleaned, and may later undergo various manufacturing processes to form new products.

One area in which recycling plays an important role is in the construction of houses and commercial buildings. Construction generally requires significant quantities of materials, some of which are amenable to recycling. Throughout the 1980s and 90s, increased public attention to the environment and the growing demand for environment-friendly construction led to the inception in 1998 of the Leadership in Energy and Environmental Design (LEED) Green Building Rating System, a third-party certification program which has become nationally accepted as a benchmark for all aspects of the design, construction, and operation of “green” buildings. The LEED rating system was developed by the U.S. Green Building Counsel (USGBC) with the purpose of establishing a common standard of measurement, recognizing environmental leadership in the building industry, and inducing competition among various companies to invent new and innovative ways of developing and utilizing environment-friendly products, services, and construction processes.

Since the advent of the LEED rating system, numerous states and local governments have adopted various incentives, such as, for example, tax credits, reduced fees, advantageous permitting, zoning allowances, grants, and low interest loans to companies and other entities which are compliant with one or more LEED categories during a particular construction job or process. LEED certified buildings and LEED certified building construction offer not only the aforementioned economic benefits, but also externalities in the form of significant environmental benefits. These benefits include reduced waste sent to landfills, conservation of energy and water, healthier and safer building occupancy, and reduced greenhouse gas emissions. Thus, modern construction of environmentally friendly buildings may benefit the occupants of the buildings, the companies involved in the construction process, and society as a whole.

### SUMMARY OF THE INVENTION

The invention provides a system and method for facilitating the recycling and tracking of post-consumer and post-industrial recyclable materials and products. The system includes a database which stores updatable data associated with the recyclable materials and the products manufactured therefrom during the recycling method, and means for acquiring and updating the data during the recycling method. The recycling method includes receiving recyclable material extracted from post consumer and post industrial sources at a manufacturing facility, acquiring information associated with the recyclable material received at the manufacturing facility, such as properties and certification(s) relating thereto, and storing the acquired information in a database for subsequent access. The recycling method may also include manufacturing a product at the manufacturing facility from the recyclable material, generating product information associated with the product such as properties and certification(s) relating thereto, and storing the product information in the database. The product may then be shipped with the product information and certification information stored in a tangible medium to provide quality certified “green” recycled products for use in building construction.

More specifically, extraction of the recycled materials involves extracting post-consumer waste glass (PCWG) from at least one post-consumer material source such as, for example, a demolition site where a building is being torn down or refurbished, or a bottling recycling facility, and/or post-consumer concrete (PCC) from at least one post-consumer material source such as the demolition site. The extraction may also include extracting post-industrial waste glass (PIWG) and/or other recyclable materials (ORM) such as, for example, fly ash from power plants or other post-industrial recyclable material sources. The recyclable materials are loaded into containers or other units which are ready for transport. The loaded containers/units are then transported to and received at the manufacturing facility.

Information associated with the recyclable material, including properties and certifications relating thereto, may be acquired during the extraction, loading, transporting, and/or receiving of the recyclable materials at the manufacturing facility. Such information may include material type, location, time of extraction, hazardous material information, time of arrival at the manufacturing facility, zip codes, mileage, etc., as well as certifications of one or more entities attesting to these properties. The information is documented and stored on paper and/or stored electronically for later access and use, preferably in a database. In this manner, the recyclable materials may be tracked and audited with supply chain information.

Manufacturing the product at the manufacturing facility includes processing the recyclable materials into a product which may be shipped directly or combined with other materials to form new products. In the preferred embodiment, the processed recyclable materials are combined with one or more other cementitious materials such as portland cement, recycled aggregate, virgin aggregate, other recyclable materials, other components such as plasticizer, and water to manufacture various cement products such as dry and wet concrete mixes and concrete masonry units (CMUs).

Information associated with the product, including product properties and certifications relating thereto, may be generated during processing, manufacturing, and/or loading of the product for shipping. Such product properties may include an identification of the components of the product, their respective weights, and any other relevant information concerning the manufacturing process and the components used to produce the product.

Shipping the products manufactured from the recyclable materials includes loading the products into outbound shipping containers/units, and providing at least a portion of the information stored in the database corresponding to the products and the various components thereof. The information shipped with the products is preferably stored in a tangible medium, though the information may simply consist of one or more identification numbers which correspond to specific database entries maintained at the manufacturing facility.

According to one aspect of the invention, the system performs computational steps and outputs reports based on the information acquired and generated during the recycling method. The data collection, chain of custody information, certifications, and tracking abilities facilitated by the system and method of the invention assists companies in providing green products with certifications relating thereto, and also allows companies to track the movement of the recyclable materials used in the green products, which assists with determining LEED points/credits as further discussed below.

In one embodiment, the recyclable materials and/or the containers/units which store them are tagged during the recycling method, preferably using radio frequency identification (RFID). The tags may be passive, in which case they store minimal information such as identification numbers, or may be active, in which case they can load, store, update, and transmit data. Information may be acquired and generated for the recyclable materials and products, respectively, by various entities inputting data and certifications electronically to the tags and/or the system.

It is anticipated that the information acquired and generated for the recyclable materials and products could be acquired by a receiving entity at the final shipping destination of the recycled products. Thus, a developer's LEEDs consultant will be able to create an entire structure or an entire portion of a structure from materials or products which the developer can reliably assert comply with specific recycling or other requirements. The developer will also be able to create an electronic or paper printout record of this information for “green” marketing purposes.

In one example, discussed in more detail below, the PCWG and PCC are both extracted from a building demolition or refurbishing site and later re-used at the same site in a recycled, processed form as a new manufacture. In another example, the PCWG, PCC, and ORM are extracted from multiple locations and later re-used at other building sites.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of the recycling method of the invention.

FIG. 2 is a schematic diagram depicting one embodiment of the architecture of the system of the invention for inputting, storing, updating, and tracking data during the recycling method of FIG. 1.

FIG. 3 is a schematic diagram of the acquisition, generation, and storage of information and certification(s) during the recycling method of FIG. 1.

FIG. 4A depicts an example of a database entry created when information associated with the recyclable material is acquired.

FIG. 4B depicts another example of a database entry created when information associated with the recyclable material is acquired.

FIG. 4C depicts an example of a bulk storage database entry created during storage of the recyclable material at the manufacturing facility.

FIG. 4D depicts an example of a database entry created when information associated with a manufactured product is generated.

FIG. 5 is a schematic diagram illustrating one example of the recycling method of FIG. 1.

FIG. 6. is a schematic diagram illustrating another example of the recycling method of FIG. 1.

### DETAILED DESCRIPTION OF THE PREFERRED EMBODIMENTS

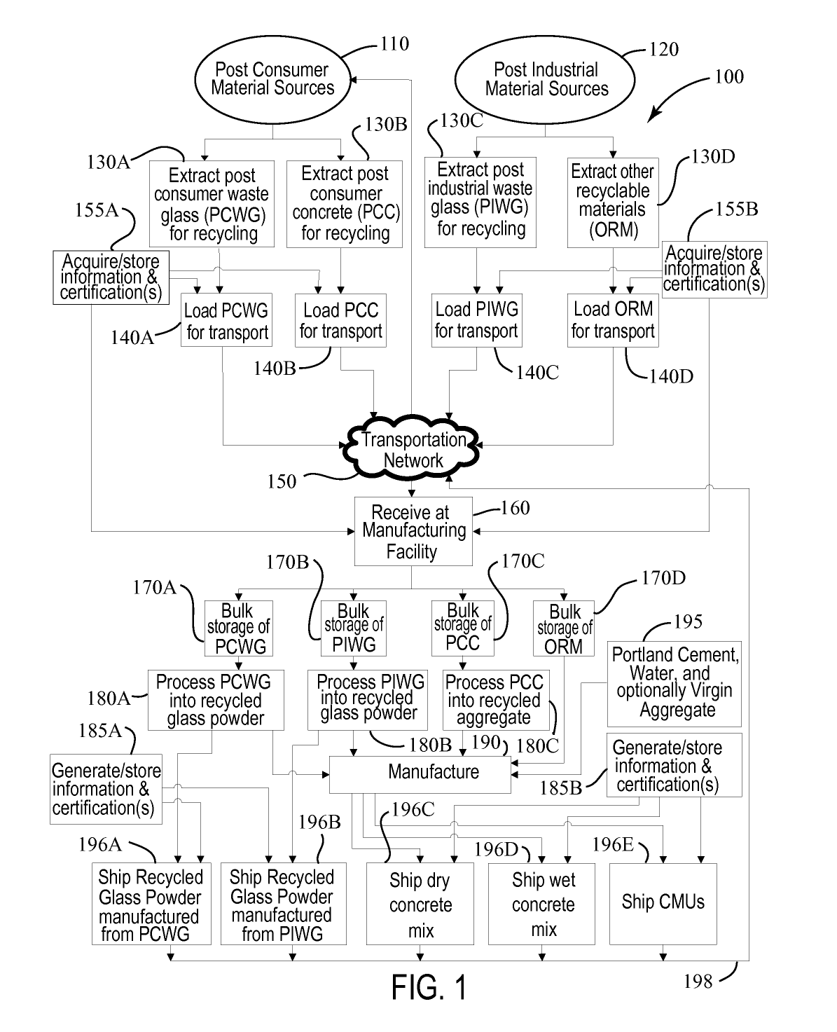

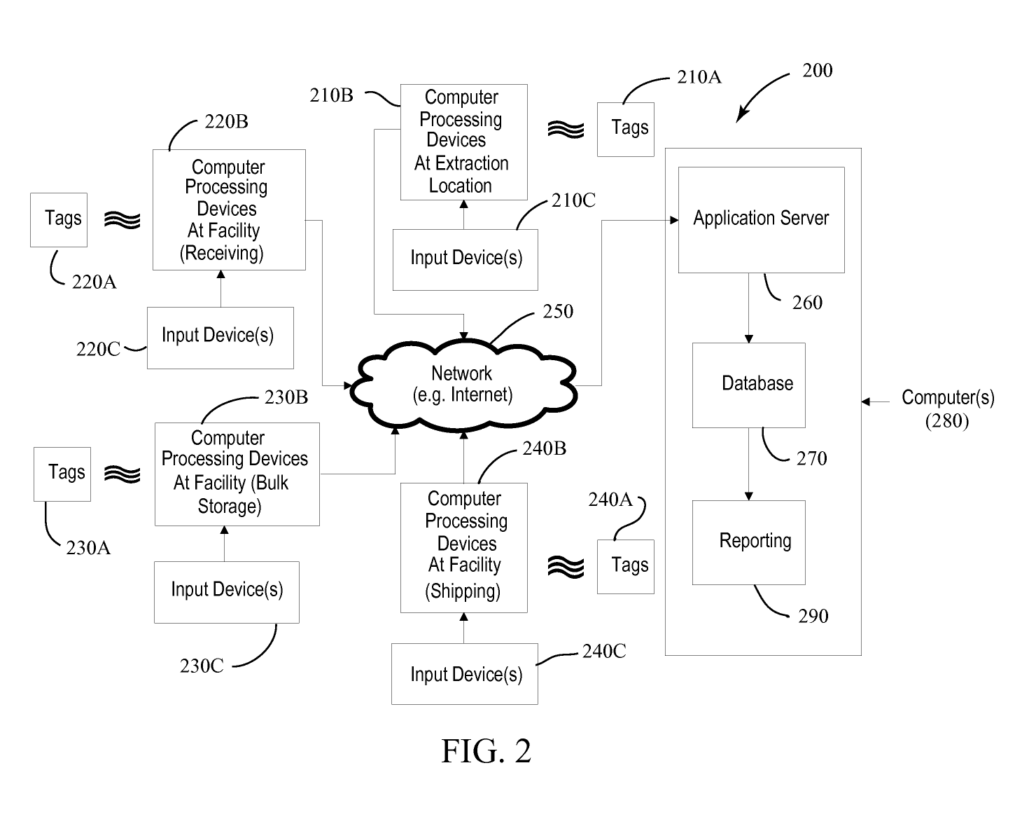

Turning to FIG. 1, a recycling method 100 for recycling and tracking post-consumer and post-industrial materials and products is shown. FIG. 1 primarily depicts the material flow path of recycled materials from their original extraction locations to their final shipment as processed goods and/or as components of manufactured products. FIG. 1 also depicts the acquisition, generation, and storage of information and certification(s) associated with the recycled materials and the products manufactured therefrom during the recycling method 100. This information may be acquired, generated, and stored on paper documents as further discussed below. An example system and process which may be used to electronically acquire, generate, and store the information and certifications(s) is discussed below with respect to FIGS. 2-4D. The recycling method 100 provides quality “green” recycled products for use in building construction and other areas while providing chain-of-custody and material property information associated with the shipped products, as well as certifications relating thereto.

Viewed from a high level, a first portion of the recycling method 100 includes receiving recyclable material extracted from post-consumer and post-industrial sources at a manufacturing facility as depicted at block 160, acquiring information at blocks 155A, 155B associated with the recyclable material (e.g., various properties of the recyclable material and certification(s) relating thereto) prior to and/or upon arrival at the manufacturing facility at block 160, and storing the acquired information, also at blocks 155A, 155B for subsequent access. A second portion of the recycling method 100 includes manufacturing a product at the manufacturing facility at block 190 from the recyclable material, generating information at blocks 185A, 185B associated with the product (e.g., various properties of the manufactured product and certification(s) relating thereto), and storing the generated product information, also at blocks 185A, 185B for subsequent access. The product may then be shipped at 198 with the associated properties and certification(s) stored in a tangible medium such as a paper or an electronic document or device. In this manner, quality certified “green” recycled products are provided.

More specifically, the recyclable materials are extracted at one or more post-consumer material sources 110, such as a demolition site where a building is being torn down or refurbished, a bottle recycling facility or the like, and/or one or more post-industrial material sources 120 such as power plants, steel mills, manufacturing plants, etc. The extraction step is depicted at blocks 130A, 130B, 130C, and 130D. At blocks 130A and 130B, post-consumer waste glass (PCWG) and post-consumer concrete (PCC) are respectively extracted from one or more post-consumer material sources 110. Post-consumer concrete may be extracted from the building being demolished, as well as from any sidewalks or roadbeds adjacent the building. At blocks 130C and 130D, post-industrial waste glass (PIWG) and other recyclable materials (ORM) such as fly ash and slag are respectively extracted from one or more post-industrial material sources 120.

A loading step is depicted at blocks 140A, 140B, 140C, and 140D. The post-consumer recyclable materials are loaded into containers or other units of storage at blocks 140A and 140B, and the post-industrial recycling materials are also loaded into containers or other units of storage at blocks 140C and 140D. Each of the PCWG, PCC, PIWG, and ORM (the “recyclable materials”) is preferably loaded into a separate container/unit. As depicted in FIG. 1, information about the recyclable materials and certification(s) related thereto may be acquired and stored at blocks 155A, 155B with respect to the recyclable materials during loading thereof. The information and certification(s) may additionally or alternatively be acquired during extraction of the recyclable materials.

For example, the information acquired at blocks 155A, 155B may include a variety of properties related to the recyclable material of a given container/storage unit, including, but not limited to, an identification number, a material type, a weight, the location (zip) of the extraction location, the date and time of pickup, hazardous material information (e.g., a hazardous material list or checklist with a corresponding ‘yes’ or ‘no’ next to each material listed), and certifications of one or more entities attesting to these properties. This information may be acquired via one or more entities (e.g., an entity at the extraction location and/or an entity loading the recyclable material into the storage unit) completing paperwork and/or checklists. The material property information may be certified through the application of a bar code or other sticker to the paperwork and/or to the container/storage unit (e.g. the application of a particular sticker to a storage unit may signify “no hazardous materials”). The certification(s) may also be generated by requiring the one or more entities to sign the completed paper documents and/or checklists. The paper documents and checklists are preferably transported with the container/storage units to the manufacturing facility (block 160) via a transportation network (block 150). The information included in the paperwork is preferably entered into a database for storage therein.

As further discussed below with respect to FIGS. 2-4D, the material properties and certification(s) relating thereto may alternatively or additionally be collected electronically using radio frequency identification (RFID) tags linked to a system which uploads inputted data and certification(s) associated with the recyclable materials to a database for storage therein.

A transportation step is depicted at cloud 150. At cloud 150, the recyclable materials are transported via trucks, barges, trains, ferries, etc. to the manufacturing facility, shown at block 160. The recyclable materials are preferably maintained in their respective containers/units while being transported to the receiving/processing facility 160 without mixing with each other. As depicted in FIG. 1, at the end of the transporting step (when the containers/storage units arrive at the manufacturing facility at block 160), additional information and certifications may optionally be acquired at blocks 155A, 155B to further maintain the audit trail of the recyclable materials.

For example, the additional information acquired at blocks 155A, 155B when the recyclable materials reach the manufacturing facility may include, but is not limited to, date and time of arrival at the manufacturing facility, mileage between the extraction site and the manufacturing facility, and certification(s) of facility personnel and/or drivers attesting to the newly inputted information. A driver may be required, for example, to certify that the recyclable material was in his or her custody and control from the time of its pickup at the extraction location to the time that the driver reached the manufacturing facility. This additional information may alternatively or additionally be inputted electronically as further discussed below with respect to FIGS. 2-4D.

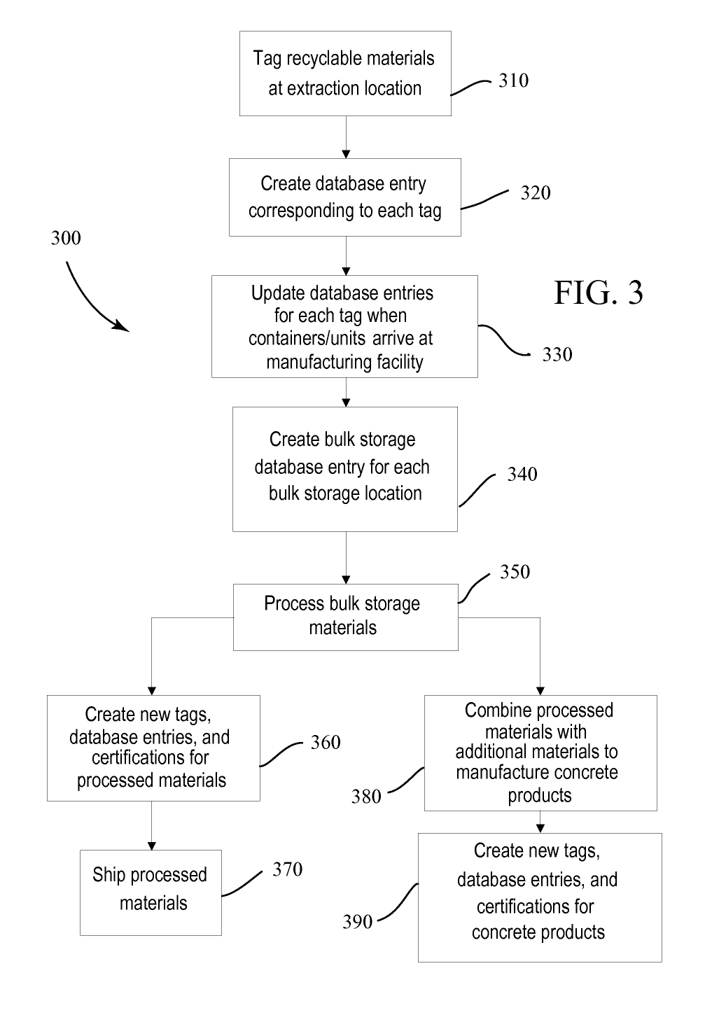

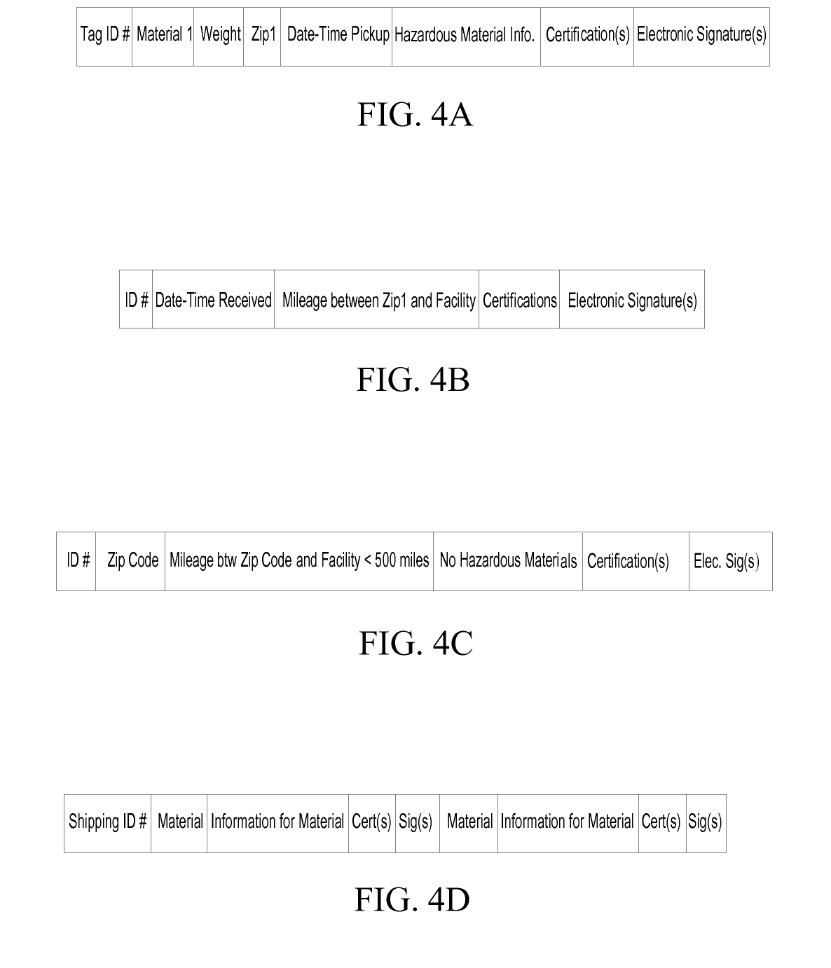

A storing step is depicted at blocks 170A, 170B, 170C, and 170D. The storage step addresses the practical needs of a typical manufacturing/processing facility which may receive very large shipments of recyclable materials from one or more extraction locations, and may wish to combine shipments of the same recyclable material from the same extraction location into a single bulk storage location. At blocks 170A and 170B, the PCWG and PIWG are moved within the manufacturing facility 160 to separate bulk storage locations. At blocks 170C and 170D, the PCC and ORM are also moved within the manufacturing facility 160 to separate bulk storage locations. Shipments of the same recyclable material from the same jobsite are preferably merged into the same bulk storage location (e.g. multiple shipments of post-consumer waste glass (PCWG) are merged into the same bulk storage location at block 170A, multiple shipments of post-consumer concrete (PCC) are merged into the same bulk storage location at block 170B, multiple shipments of post-industrial waste glass (PIWG) are merged into the same bulk storage location at block 170C, and multiple shipments of other recyclable materials (ORM) are merged into the same bulk storage location at block 170D. It will be appreciated that during this bulk storage step, a record (e.g., a bulk storage database entry) should be created and maintained which outlines the properties common to the material of each bulk storage location. In this manner, important property information associated with and common to the recyclable material from multiple shipments in each bulk storage location (e.g., material type, hazardous material checklist, certifications, etc.) is maintained. Alternatively, shipments of recyclable material may be stored separately in the manufacturing facility so as not to lose acquired information which is unique to particular shipments (e.g., arrival time at the facility, special certifications, etc). The level of detail which a particular manufacturing facility desires will of course depend upon the specific parameters of a given project. The storage step is further discussed below with respect to FIGS. 3, 4C.

A processing step of the recycling method 100 is depicted at blocks 180A, 180B, and 180C. At blocks, 180A and 180B, the PCWG and PIWG are retrieved from their respective bulk storage locations and separately processed into recycled glass powder. It will be appreciated that the processing of the PCWG and PIWG into recycled glass powder may be achieved by a number of different processes known in the art, including, for example, the processes disclosed in co-owned U.S. Pat. No. 7,413,602, which is herein incorporated by reference in its entirety. In addition, other continuous and batch processes may be used. At block 180C, the PCC is retrieved from its bulk storage location and processed into recycled aggregate. One process includes repeatedly crushing or lacerating the post-consumer concrete with a cone crusher or hammer mill to suitable aggregate size. The PCC is initially crushed using a hammer mill or a cone mill to a size between sand and ⅞″. The PCC is then screened using a 60 Mesh filter to isolate the crushed PCC grains which are smaller than ⅞″. PCC grains which are larger than ⅞″ are fed back into the hammer mill or cone mill for further crushing. The PCC grains which are smaller than ⅞″ are washed with water and then stored or shipped as wet mix or dried to be stored or shipped as dry mix.

A manufacturing step of the recycling method 100 is depicted at block 190. At block 190, the recycled glass powder processed from at least one of the PCWG and PIWG at blocks 180A and 180B is combined with the recycled aggregate processed from the PCC at block 180C, as well as with portland cement, water, plasticizers, virgin aggregate, and other recycled materials as required to manufacture various concrete products, including, for example, the dry and wet concrete mixes and CMUs. The ratios of cementitious components to aggregate to water is determined according to the application and with the skill level of one skilled in the art.

A shipping step of the recycling method 100 is depicted at blocks 196A, 196B, 196C, 196D, and 196E. At blocks 196A and 196B, recycled glass powder processed from, respectively, PCWG at block 180A and PIWG at block 180B, is loaded into outbound shipping containers/units. This provides for uses of the processed glass powder other than in the manufacture of concrete products. For example, such glass powder can be used as a filler in the manufacture of plastics, manufactured countertops, paints, etc. At blocks 196C and 196D, dry concrete mixes and wet concrete mixes, manufactured at block 190, are also respectively loaded into outbound shipping containers/units. At block 196E, CMUs manufactured at block 190 are loaded into outbound shipping containers/units.

As depicted in FIG. 1, information and certification(s) may be generated and stored at blocks 185A, 185B after the manufacturing step and prior to shipping the products to further maintain the audit trail of the recyclable materials and the products made therefrom. This information may include, for example, an identification of each material included in the manufactured product, an amount (weight and/or volume) corresponding to each material, a regional amount (weight and/or volume) of each material (further discussed below), as well as any number of other relevant properties and certifications(s) acquired and stored with respect to any of the components of the product during prior steps of the recycling method or during the manufacturing process. The certifications attesting to the properties of the product being shipped may also be generated in the same manner as discussed above. The information may also be inputted/generated electronically as further discussed below with respect to FIGS. 2-4D.

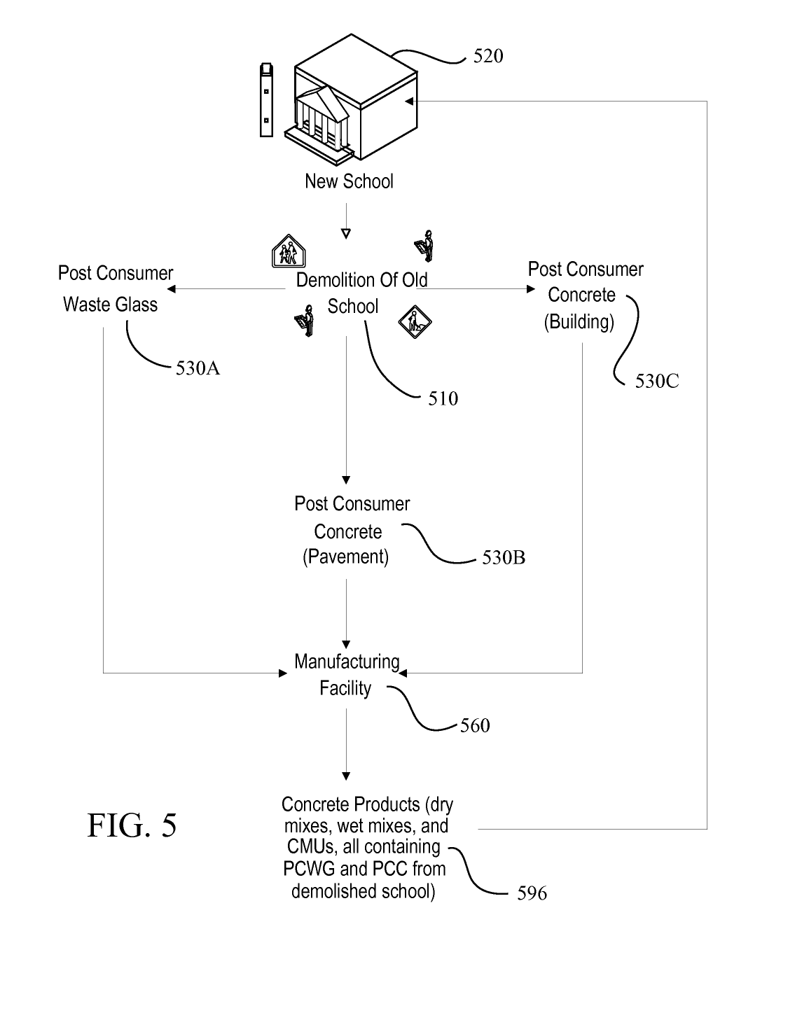

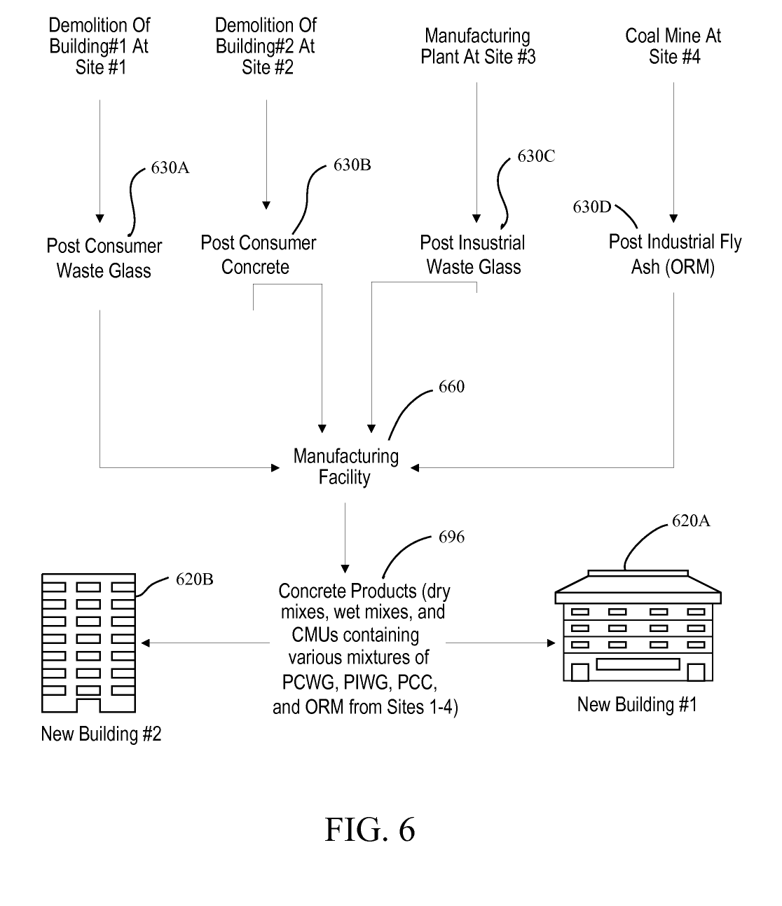

The outbound products loaded at blocks 196A-196E are then shipped via the transportation network 150 to one or more job sites, some of which may be located at the same site as the post-consumer material sources 110. Specific examples of the recycling method 100 are further discussed below with respect to FIGS. 5-6.

While mediums such as paper-signed checklists and material custody documents containing stickers, bar codes, and the like may be used as discussed above to acquire, generate, and store information and certifications associated with the recyclable materials and products manufactured therefrom (e.g., at blocks 155A, 155B, 185A, and 185B), it will be appreciated that an electronic system for performing the recycling method 100 may alternatively or additionally be utilized. In fact, given the nature of recyclable building materials such as glass and concrete, which (1) can be quite bulky; (2) are typically loaded in large quantities; and (3) may pose difficulties or even potential dangers for an operator trying to obtain a line of sight with a specific bar code on account of the material weight, jagged edges, etc., utilizing RFID technology may be beneficial. If a large volume of material handling and storage is necessary for a given project, and a high level of detail is desired with regard to tracking the material properties and chain of custody information of specific shipments, then RFID technology may be a suitable choice for performing the recycling method 100.

Radio frequency identification (RFID) technology passes information from one device to another using radio waves. The device which identifies the first device or object is called a tag. An RFID tag is typically capable of sending data that it receives to another device called a reader. The reader extracts the data from the tag and communicates it to other parts of the RFID system. This information may also be passed from the reader to the tag, stored within the tag, and read at a later time by another reader device. Most reader devices consist of a radio transmitter, a radio receiver, an antenna, signal processing circuitry, control circuitry, and a data interface to an external device or system. The addition of a network and/or computers to the reader provides added capacity for functionality associated with the data collection, storage, and transmission.

Turning to FIG. 2, an example data collection and tracking system 200 facilitates the electronic acquisition, generation, storage, updating, and tracking of material properties and certifications relating thereto during the recycling method 100. The system 200 includes tags 210A, computer processing devices 210B, and input devices 210C at the extraction location for use during the extraction step (blocks 130A, 130B, 130C, and 130D of FIG. 1) of the recycling method 100; tags 220A, computer processing devices 220B, and input devices 220C at the manufacturing facility 160 for use during the transfer of the recycling materials from the transportation network 150 to the manufacturing facility 160; tags 230A, computer processing devices 230B, and input devices 230C at various bulk storage locations of the manufacturing facility 160 for use during the storage step (blocks 170A, 170B, 170C, and 170D of FIG. 1) of the recycling method 100; and tags 240A, computer processing devices 240B, and input devices 240C at shipping areas of the manufacturing facility 160 for use during the shipping step (blocks 196A, 196B, 196C, 196D, and 196E of FIG. 1) of the recycling method 100.

The tags 210A, 220A, 230A, and 240A (the “RFID tags”) may each consist of an integrated circuit attached to an antenna. Data is stored on the integrated circuit and transmitted though the antenna. The RFID tags may be passive, in which case no battery or other power source is required, or active, in which case the tags are powered by a battery or other power source (not shown). The tags may be read-only, read-write, or a combination of the two as discussed in U.S. Pat. No. 7,497,370, which is hereby incorporated by reference herein in its entirety. For example, data such as an associated serial number corresponding to the tag may be permanently stored on the tag while other memory is left available for later encoding or updating by a user (e.g., inputted to the tag via the computer processing devices and/or input devices). This other updatable memory of the tags may be stored on the tags for later retrieval and/or automatically transmitted to a database 270 over the network (Internet) 250 by an application server 260. For example, the application server 260 may utilize a user interface which appears on the computer processing device 210B for inputting data. Encryption algorithms may also be incorporated to protect the integrity of the data passing between the tags, computer processing devices, and the network. The computer processing devices 210B, 220B, 230B, and 240B and input devices 210C, 220C, 230C, and 240C may be integrated into handheld devices/terminals and/or fixed and positioned at specific locations. Collected data may be passed via cables or wireless networks to the application server 260 and database 270, and accessed by one or more host computers 280 at the manufacturing facility 160. The host computers 280 may also be linked to the data collecting tags, computer processing devices (e.g., reader/writer devices), and input devices.

As discussed above, the tags, computer processing devices and input devices of FIG. 2 are all operably coupled over the network 250 to a database 270 via an application server 260. The one or more host computers 280 access the database 270 to perform various functions, such as, for example, computational analysis of data inputted to the database 270 and reporting 290 related thereto. The data collection and tracking system 200 of FIG. 2 can be used to electronically acquire, generate, store, analyze, and track the information and certifications relating to the recyclable products at blocks 155A, 155B, 185A, and 185B or at other stages of the recycling method 100 as further explained below with respect to FIGS. 3-4C. It will be appreciated by those skilled in the art that the data collection and tracking system 200 should be flexible enough to allow a variety of input types in addition to the RFID tags, such as manual input, bar codes, scanned paperwork, checklists, affidavits, etc. The input devices 210C, 220C, 230C, and 240C may consist of fax machines, scanning devices, computers for entering data into word processing, spreadsheet, or database software, and uploading the data over the network 250 to the application server 260, though it will be appreciated that the amount of data inputted should not be so excessive as to impair the material loading process or render it inefficient. The level of detail provided may be a decision unique to each project depending upon the needs of a given company, supplier, manufacturer, and/or material handler. It will be appreciated that in using the data collection and tracking system 200, real-time supply chain information may be stored in the RFID tags and/or uploaded to the database 270 of the system 200 at various steps of the recycling method 100. A sample tagging, data entry, and tracking process is further discussed below.

Referring to FIGS. 1-4C, an example tagging, data entry, and tracking method 300 is used to electronically enter and store data and certifications pertaining to the recyclable materials and products manufactured therefrom at various steps of the recycling method 100, and to track the recyclable materials from their initial extraction at the post-consumer material sources 110 and post-industrial material sources 120 to their final shipping destination as recycled products. First, as depicted at block 310, the recycled products are tagged at the extraction (material source) location during the loading step (blocks 140A, 140B, 140C, 140D of FIG. 1) of the recycling method 100 with the tags 210A (FIG. 2). As discussed above, the tags 210A may be RFID tags or simply bar coded paper or plastic sheets containing serial numbers and/or other information. The containers/units which are loaded with the recycled materials may be equipped with the tags 210A prior to or after the recyclable material are loaded therein. The tags 210A are then scanned using the computer processing devices 210B.

The scanning of the tags 210A by the computer processing devices 210B creates a new database entry in the database 270 for each scanned tag 210A as depicted at block 320. At this point, the new database entry created for each scanned tag 210A contains minimal information, such as, for example, the serial number or ID number of the tag 210A. Data is then inputted to the new database entry by on-site personnel. The inputted data pertains to the specific recyclable material loaded into the corresponding container/unit. As depicted in FIG. 4A, such data may include, but is not limited to, tag identification number and various properties such as material type, weight, location (zip), date and time of pickup, hazardous material information (e.g., a hazardous material list with corresponding ‘yes’ or ‘no’ inputs next to each material listed), and certifications and/or electronic signatures of appropriate on-site personnel attesting to the inputted data. This data may be inputted in a number of ways via the handheld computer processing devices 210B and/or input devices 210C.

For example, after loading a recyclable material into a container/unit at the loading step of the recycling method 100, a material handler could scan the tag 210A with the computer processing device 210B, input the material type, zip code of the extraction site, and date/time of pickup via a user interface which appears on the computer processing device 210B and is linked with the application server 260. The material handler could then generate a certification for this inputted data via an electronic signature interface, again by using the computer processing device 210B. Another individual having knowledge of the hazardous material information pertaining to the loaded recyclable material (e.g., the on-site contractor in charge of demolishing the building or removing the materials) could then input the hazardous material information, also by using a computer processing device 210B and/or an input device 210C. If the on-site contractor is in possession of any paper or electronic documentation on which he is relying to make the material certifications, such documents could be scanned/uploaded and stored in the system 200 using the input devices 210C. These paper or electronic documents may be uploaded to the application server 260 and linked to the new database entry via the tag identification number, which could be selected, inputted again, or scanned from the tag 210A when the documents are uploaded. The new database entries and associated documents, if any, pertaining to each loaded recyclable material may thus be created and certified prior to moving the recyclable material from the extraction site.

At block 330, the new database entries created for each tagged material are updated with additional data when the respective container/units arrive at the manufacturing facility 160 for processing. The additional data is uploaded using the computer processing devices 220B and/or input devices 220C at the facility 160. As depicted in FIG. 4B, this additional information may include, but is not limited to, date and time of arrival at the manufacturing facility, mileage between the extraction site and the manufacturing facility (either inputted by the user or calculated automatically by the system 200 based on the known zip code of the facility and the zip code of the extraction site which was entered when the material was picked up), and certifications of facility personnel and/or drivers attesting to the newly inputted information. For example, a driver may be required to certify that the recyclable material was in his or her custody and control from the time of its pickup at the extraction site to the time that the driver reached the manufacturing facility.

It will be appreciated that when the recycled material arrives at the facility, it may be necessary to transfer the recycled material from the containers/units which housed the material through the transportation network 150 to new containers/units at the manufacturing facility. If so, the tags 210A may be transferred with the recyclable material to the new containers/units, or new tags 220A may be associated with the material in the new containers/units. If new tags 220A are associated, then the new tags 220A may be encoded with the same identification number as the corresponding tags 210A. Alternatively, if the new tags 220A have different identification numbers, then the database entries corresponding to the original identification numbers of the tags 210A may be updated to correspond to the new identification numbers of the tags 220A.

At block 340, bulk storage database entries are created for each bulk storage location at the storage step of the recycling method 100 (boxes 170A, 170B, 170C, and 170D of FIG. 1). Shipments of the same recycled material extracted from a single extraction site which have respective database entries and certifications that fall within pre-determined parameters (e.g., parameters determined by the processing facility) may be combined and stored in the same bulk storage location as discussed above. The bulk storage database entries may be created by facility personnel who have access to the database 270 of the system 200 and are in charge of directing the various shipments to their respective bulk storage location. New tags 230A may be utilized at each bulk storage location. As depicted in FIG. 4C, the bulk storage database entries may include some or all of the information acquired during extraction, loading, transport, and receiving of the recyclable materials (e.g., the information depicted in FIGS. 4A and 4B).

For example, if a manufacturing facility wishes to produce concrete products which (1) contain recycled glass powder produced from post-consumer waste glass; (2) do not contain hazardous materials; and (3) comprise recycled content (including the recycled glass) which is extracted, processed, and manufactured within 500 miles of the project site to which the products are being shipped, then incoming shipments of the recycled content received at the manufacturing facility having certifications and associated data indicating that the recycled content meets these parameters may be combined into a single bulk storage location and tagged. The bulk storage database entry is then created which indicates that all of the materials at that bulk storage location meet these parameters.

Alternatively, all shipments of recyclable materials received at the manufacturing facility may be maintained separately in the manufacturing facility, in which case information which has been acquired for each shipment and is unique to each shipment (e.g., arrival time, weight, etc.) is maintained.

Block 350 of FIG. 3 corresponds to the processing step of the recycling method 100 (blocks 180A, 180B, and 180C of FIG. 1). The processing of the bulk storage materials (PCWG, PIWG, and PCC) into glass powder and recycled aggregate may vary depending upon the capabilities and attributes of each facility. As discussed above with respect to FIG. 1, after processing, the glass powder and/or recycled aggregate may be shipped directly (blocks 196A, 196B, and 196C of FIG. 1). The tagging and database entry steps needed to directly ship the recycled glass powder and/or recycled aggregate are depicted at block 360. At block 360, the recycled materials are loaded into outbound shipping containers/units and new shipping tags 240A (FIG. 2) are placed into the outbound shipping containers/units and scanned using the computer processing devices 240B.

A shipping database entry is created for each shipping tag. The shipping database entry contains information on the content of the shipped material (e.g. glass powder or recycled aggregate), as well as information copied from the database entries for the bulk storage locations from which the recyclable materials were pulled (e.g., PCWG, PIWG, etc). Each shipping database entry may also contain certification(s) of facility personnel attesting to the information inputted to the shipping database entry. These certification statements may appear in a user interface on the computer processing devices 240B, and may utilize electronic signatures as discussed above. At block 370, the outbound recycled products are shipped with their respective tags 240A. As discussed above, the tags 240A may store all of the data stored in the corresponding database entry, or may simply store an identification number which can be traced back to the facility's database 270 to obtain the corresponding data. Alternatively, the outbound product may be shipped without a tag but in conjunction with paper or electronic certification of its contents as discussed above, including sufficient information to allow for calculation of permitted LEED credits as further discussed below.

Block 380 corresponds to the manufacturing step of the recycling method 100 (block 190 of FIG. 1) in which the glass powder and/or recycled aggregate is combined with other materials, including portland cement, water, and optionally virgin aggregate and plasticizer to create various concrete products. At block 390, the concrete products are placed into outbound shipping containers/units, tags 240A are placed in or on the shipping containers/units, and shipping database entries are created for the outbound concrete products. As depicted in FIG. 4D, the shipping database entry preferably contains information copied from the database entry of each bulk storage location from which the recycled materials were pulled, as well as additional information, such as, for example, the content and percentages of the recycled materials in the outbound concrete products. Certifications and electronic signatures attesting to the shipping database entries may be generated in the same manner discussed above.

It is anticipated that the data and certifications associated with the outbound concrete products and/or glass powder and recycled aggregate could be uploaded from the tags 240A by a receiving entity after the materials/products reach their final destination (e.g., to preserve the audit trail). Thus, a developer or contractor could create an entire structure or an entire portion of a structure from materials or products which the developer can reliably assert comply with specific recycling or other requirements. The developer could also create an electronic or paper printout record of the associated data and certifications in support of, for example, marketing his or her “green” construction services.

Turning to FIG. 5, one example of implementation of a method of the present invention is shown in which recyclable materials are extracted from a demolition location 510 of an old school and used to build a new school building 520 at the same location 510. As shown, the recyclable materials include post-consumer waste glass 530A and post-consumer concrete 530B extracted from the demolition location 510. The post-consumer waste glass 530A is provided as windows removed from the old building. The recyclable materials also include post-consumer concrete 530C which may be extracted from both the structure of the old school building as well as the pavement surrounding the building (driveways, sidewalks, etc.). The recyclable materials 530A, 530B, 530C are extracted, loaded, and transported through the transportation network to the manufacturing facility 560, and processed and manufactured into “green” concrete products 596. The concrete products 596 are then shipped to build the new school 520 at the demolition location 510 of the old school, all in accordance with the recycling method 100 described above.

Turning to FIG. 6, another example of the implementation of the method of the present invention is shown in which two new buildings 620A, 620B are constructed at two different sites using concrete products 696 containing recycled post-consumer waste glass 630A, post-consumer concrete 630B, post-industrial waste glass 630C, and post-industrial fly ash 630D. These recycled materials are extracted from four different sites and loaded and transported through the transportation network to the manufacturing facility 660, and processed and manufactured into “green” concrete products. The concrete products are shipped back to two different building sites to build two new buildings, all according to the recycling method 100 described above.

It will be appreciated that the information collected manually and/or electronically during the recycling method 100 may be used to generate a report which provides a summary of relevant information associated with an outbound product. By way of example, Table 1 lists a number of useful properties:

TABLE 1
Concrete Product Report

| | | Distance | Weight |
|---|---|---|---|
| | | Between Project | Contributing |
| | | Site & Extraction | to Regional |
| Components | Weight (lbs) | Site (miles) | Extraction |
| Cement | 360 | 200 | 340 |
| Recycled Glass | 85 | 711 | 0 |
| Powder from PCWG | | | |
| Aggregate from PCC | 2125 | 148 | 2125 |
| Screenings | 2000 | 93 | 2000 |
| Plasticizer | 4.2 | 57 | 4.2 |
| Water | 2.05 | 96 | 2.05 |
| Component Totals | 4556.25 | | 4471.25 |
| % of Regionally | 4471.25/ | | 97.10% |
| Extracted Materials | 4556.25 | | |
| Hazardous Materials: | | | |
| (None) | | | |

This sample reporting table may be outputted by, for example, the reporting function (block 290 of FIG. 2) of the host computer 280. As shown above, the reporting table displays some of the data associated with the components of a concrete masonry unit (CMU) loaded for transport (depicted at block 196E of the recycling method 100). The data includes an identification of the components, their respective weights, the distance between the extraction site of each component and the project site (e.g., the destination to which the product is being shipped), the weight contributing to “regional extraction” of each component, and the percentage of regionally extracted materials (e.g., the total weight of the regionally extracted materials divided by the total weight of the CMU).

Here, a “regional extraction” designation means that the component was extracted, processed, and manufactured within 500 miles of the project site to which the component is ultimately shipped (e.g. in processed form by itself or as part of a product as in Table. 1). For example, as shown, three hundred-sixty lbs of cement were used, three hundred-forty lbs of which were regionally extracted (e.g., extracted 200 miles from the project site). Eighty-five pounds of post-consumer waste glass (PCWG) was included in the CMU, but was extracted 711 miles from the job site and thus is not “regionally extracted”. 2,125 lbs of recycled aggregate formed from post consumer concrete was included in the CMU, and was extracted 148 miles from the job site, and thus is “regionally extracted.”The extent to which recycled materials are used in concrete products as replacement material and the extent to which these replacement materials are regionally extracted have bearing on how “green” the product is, and may also have bearing on the extent to which a company can qualify for LEED credits as further discussed below.

It will be appreciated by those skilled in the art that the method 100 disclosed herein will enable a user to not only track the information reported with the product, but also to certify it and provide an audit trail documenting the composition and reported properties of the products and components. The information included in the above table may, for example, assist a company in reporting and documenting that the company has met the prerequisites of certification for Leadership in Energy and Environmental Design (LEED) credits after a year of work on a particular job. It will also be appreciated that the audit trail provided by the system and method of the invention may provide a defense for and/or enable a proper investigation of the actual processes and materials which the company used for a particular project.

LEEDS credits follow a standard rating system which is covered by six comprehensive categories. These categories are (1) Sustainable sites; (2) Water efficiency; (3) Energy and atmosphere; (4) Materials and resources; (5) Indoor environmental quality; and (6) Innovation and design process. The LEED rating system also contains a bonus category titled “Regional Priority”, which relates to the location of the pickup and processing of recyclable materials relative to the destination to which they are ultimately shipped. The Materials and Resources category of the LEED rating system is of particular interest to masonry suppliers and other companies involved in furnishing and supplying raw and manufactured products to be used for construction at a job site.

By way of example, processed glass which acts as a supplementary cementitious material (SCM) (e.g., the recycled glass powder produced from post-consumer waste glass listed in the above table functions as a pozzolan and can provide direct replacement for a portion of the portland cement in the concrete product) enables the cement product to potentially contribute to Material and Resource Credits over the course of a given project. If the SCM comprises 30% by weight, an additional Innovation and Design point can be achieved in the LEED project for exemplary performance.

The use of supplementary cementitious material and the use of recycled concrete, etc as discussed above may contribute to Material and Resource Credits 3.1, 3.2, 4.1 and 4.2. For example, if the sum of such re-used materials contributes to 5%, based on cost, of the total value of materials on the project, then one credit or point is earned under MR 3.1. If the materials contribute to 10% based on cost, then an additional credit or point is earned under MR 3.2. If the sum of post-consumer recycled content plus one-half of the pre-consumer content (material diverted from the waste stream during the manufacturing process) constitutes at least 10% (based on cost) of the total value of the materials in the project, then one credit is earned under MR 4.1 (and an additional point under MR 4.2 is earned if the sum is at least 20%). In addition, Material and Resource Credits 5.1 and 5.2 may be achieved by meeting the 500 mile regionally extracted, processed, and manufactured requirement (e.g., as shown by the regional extraction data in the above table). If 10% (based on cost) of the materials are “regional”, then a credit under MR 5.1 is earned. If 20%, then an additional credit under MR. 5.2 is earned. An additional Innovation and Design point can potentially be achieved if at least 40% of the components of the product are regionally harvested, extracted, and manufactured.

The regional amount of each material in the product may be determined and later verified using the recycling method 100 from information acquired and stored at the extraction, loading, and/or receiving steps (e.g., at blocks 155A, 155B), as well as from the information generated after manufacturing the product (e.g., at blocks 185A, 185B) as discussed above. By tracking the information associated with the components and products shipped from the manufacturing facility and storing the information in the database 270, totals for each category of LEED can be calculated at various points in the project, such as, for example, one year into the project when certification is typically established. The information stored in the database 270 may also be beneficial for establishing a company's right to tax credits or other benefits offered for being compliant with federal guidelines pertaining to demolition and construction of government buildings and public sector projects.

Thus, use of the recycling method 100 of the invention will allow contractors, material handlers, masonry companies, and others involved in demolition and construction processes to obtain and verify entitlement to LEED credits (and entitlement to LEED Gold, Silver, or Platinum certifications) by virtue of the improved ability to collect, store, and certify information associated with the recyclable materials and products, and to track the recyclable materials and products throughout the recycling process.

It is also anticipated that additional modifications could be made to the system 200 described above, such as, for example, integrating the RFID technology with GPS to further enhance tracking capability of the recycled products. The processing and manufacturing steps of the recycling method 100 may be done on product lines specifically devoted to recyclable products so that certain parameters or certified characteristics of the materials (e.g. absence of contaminants or hazardous materials) are maintained.

There have been described and illustrated herein several embodiments of a system and a method for handling recyclable materials. While particular embodiments of the invention have been described, it is not intended that the invention be limited thereto, as it is intended that the invention be as broad in scope as the art will allow and that the specification be read likewise. Thus, while particular tags, computer processing devices, input devices, and paper documents have been disclosed, it will be appreciated that other tracking and data entry documentation may be used. In addition, while paper bar-coding has been disclosed for a database system, it will be appreciated that other forms of tracking and coding devices may be used. While a particular network architecture has been disclosed, it will be understood that other architectures may be used. Also, while a particular recycling method has been disclosed, it will be recognized that a number of the steps of the recycling method may be omitted or simplified. Furthermore, while RFID technology has been disclosed for use with a particular network architecture for tagging and creating database entries, it will be understood that other types of tagging and database creation may be utilized. Moreover, while particular examples have been disclosed which employ the recycling system and method to recycle post-consumer and post-industrial materials to build buildings, it will be appreciated that other examples could be employed as well in which sidewalks, patios, and architectural structures could be built, and that the recycled content extracted could be used in numerous other products such as plastics, paint, countertops, etc. It will therefore be appreciated by those skilled in the art that yet other modifications could be made to the provided invention without deviating from its spirit and scope as claimed.

What is claimed is:

1. In a system in which material that includes recyclable content is extracted from a first location, loaded into or on a transport unit, and transported to a manufacturing facility at a second location, the manufacturing facility for manufacturing product from the recyclable content of the material supplied thereto, wherein at least one entity certifies at least one property related to the recyclable content of the material of the transport unit and generates at least one certification corresponding thereto, a method for handling and tracking the material, the method comprising:
(a) at the manufacturing facility, receiving the transport unit and the material associated therewith;
(b) acquiring information associated with the recyclable content of the material of the transport unit, the information of (b) including data representing i) at least one property of the recyclable content and ii) at least one certification corresponding to the at least one property of the recyclable content; and
(c) storing the information of (b) in a database for subsequent access.

2. A method according to claim 1, wherein:
the recyclable content is selected from the group consisting of post consumer waste glass, post industrial waste glass, post consumer concrete, and fly ash or materials containing same.

3. A method according to claim 1, wherein:
an electronic identification means is associated with the material received in (a) and stores the information acquired in (b).

4. A method according to claim 3, wherein:
the electronic identification means is one of an RFID tag and a bar code.

5. A method according to claim 1, wherein:
a written identification means is associated with the material received in (a) and stores the information acquired in (b).

6. A method according to claim 1, wherein:
the at least one property related to the recyclable content and certified by the at least one entity is selected from the group consisting of an extraction location, an extraction date, hazardous material information, a weight, and a volume.

7. A method according to claim 1, wherein:
the at least one certification includes a certification relating to custody of the material during at least one of extraction of the material at the first location and transport of the material between the first and second locations.

8. A method according to claim 1, wherein:
the information of (b) is acquired at at least one of the first and second locations.

9. A method according to claim 1, further comprising:
(d) manufacturing a product at the manufacturing facility from the recyclable content of the material received in (a);
(e) generating information associated with the product manufactured at step (d), the information generated in (e) including data representing i) at least one property of the recycled content of the product and ii) at least one certification corresponding to the at least one property of the recycled content of the product; and
(f) storing the information of (e) in the database for subsequent access.

10. A method according to claim 9, wherein:
the manufacturing of (d) includes processing the recyclable content of the material received in (a)

11. A method according to claim 10, wherein:
the recyclable content comprises waste glass, and the processing of the recyclable content of (d) forms glass powder from the recyclable content.

12. A method according to claim 10, wherein:
the recyclable content comprises post consumer concrete, and the processing of the recyclable content of (d) forms aggregate from the recyclable content.

13. A method according to claim 9, wherein:
the product manufactured in step (d) is a concrete product.

14. A method according to claim 13, wherein:
the concrete product is selected from the group consisting of a concrete masonry unit, a wet concrete mix, and a dry concrete mix.

15. A method according to claim 14, wherein:
the concrete product includes portland cement, a replacement for the portland cement, and an aggregate.

16. A method according to claim 15, wherein:
a portion of the aggregate is derived from the material received in (a).

17. A method according to claim 15, wherein:
the replacement for the portland cement is derived from the material received in (a).

18. A method according to claim 15, wherein:
the at least one property stored in (f) includes an amount corresponding to each of the portland cement, the replacement for the portland cement, and the aggregate.

19. A method according to claim 18, wherein:
the at least one property of the recycled content stored in (c) includes an extraction location of the recycled content.

20. A method according to claim 19, wherein:
at least one property stored in (f) includes an extraction location of at least one other material included in the product, and
wherein, the extraction location of the recyclable material stored in (c) and the extraction location of the at least one other material in the product stored in (f) are used to determine a regional amount of recyclable material included in the product and a regional amount of other material included in the product.

21. A method according to claim 9, further comprising:
(g) shipping the product manufactured in (d) with information stored in (c) and (f) associated with the product.

22. A method according to claim 21, wherein:
The information shipped with the product in (g) is embodied in an electronic identification means.

23. A method according to claim 22, wherein:
the electronic identification means is one of a bar code and an RFID tag.

24. A method according to claim 21, wherein:
a written identification means is associated with the product shipped in (g) and stores the information shipped with the product.

25. A method according to claim 21, wherein:
the information associated with the product shipped in (g) includes a certification corresponding to at least one property of the recycled content included in the product.

26. A method according to claim 25, wherein:
the at least one property of the recycled content of the product shipped in (g) includes extraction location information.

27. A method according to claim 25, wherein:
the at least one property of the recycled content of the product shipped in (g) includes hazardous material information.

28. A method according to claim 25, wherein:
the at least one property of the recycled content of the product shipped in (g) is selected from the group consisting of an extraction date, an extraction time, a weight, and a volume.

29. A method according to claim 21, wherein:
the product is shipped to the first location.

30. A method according to claim 29, wherein:
the first location is one of a bottling facility and a demolition site.

31. A method according to claim 1, further comprising:
(h) extracting additional material from at least one other location, said additional material including additional recyclable content; and
(i) transporting the additional material from the at least one other location to the manufacturing facility,
wherein, the product manufactured at step (d) includes at least a portion of the additional recyclable content.

32. A method according to claim 1, further comprising:
(j) providing a server and a plurality of computer processing devices which interact with the database via the server over a network to acquire the information of (b).

33. A method according to claim 32, wherein:
a tag is provided with the material for storing the information of (b), and a given computer processing device interacts with the tag to upload the information of (b) to the database.

34. A method according to claim 32, further comprising:
(k) providing a host computer at the facility, the host computer operably coupled to the database and capable of generating reports containing information stored in the database.

35. A product, comprising:
(a) concrete goods, said concrete goods including recycled content extracted from a first location and transported to a manufacturing facility at a second location; and
(b) a certification certifying at least one property relating to the recycled content of the concrete goods.

36. A product according to claim 35, wherein:
said concrete goods are selected from group consisting of a concrete masonry unit, a wet concrete mix, and a dry concrete mix.

37. A product according to claim 36, wherein:
said concrete goods include portland cement, a partial replacement for the portland cement produced from the recycled content, and an aggregate.

38. A product according to claim 37 wherein:
said recycled content includes at least one of post consumer waste glass and post industrial waste glass.

39. A product according to claim 37, wherein:
said aggregate includes concrete.
